(19) United States
(12) Patent Application Publication
(10) Pub. No.: US 2011/0298415 A1
(43) Pub. Date: Dec. 8, 2011

(54) Jump starter and module power station

(76) Inventor: Guil Hetzroni, Coral Springs, FL (US)

(21) Appl. No.: 12/796,283

(22) Filed: Jun. 8, 2010

(51) Int. Cl. H02J 7/00

(52) U.S. Cl. 320/104

(57) ABSTRACT

A portable jump starter includes a hand-held case with a battery for starting a vehicle; a receiving station within the case; and, a module comprising a self-contained appliance. The module includes an electrical receptacle adapted to mate with the electrical outlet. The receiving station may include splines on its bottom wall and side walls keyed to channels on the module. Retaining blocks may be used immediately adjacent the receiving station to prevent vertical movement of the module. The electrical receptacle may be recessed within a wall of the module so that the electrical outlet remains flush with the wall of the module. An adaptor may be included to connect a module to an alternate power source.

### TECHNICAL FIELD

In the field of electricity and battery charging where one battery charges another and specifically involving using a jump starter to start a vehicle with a weak or dead battery, a portable jump starter is disclosed having a built-in module power station enabling powering of appliances adapted to engage the module power station.

### BACKGROUND ART

The prior art in the portable jump starter subject area discloses hand held units, including those with outlets for connecting or powering other components. None, however, discloses a portable jump starter with a receiving station for a self-contained appliance module as in the present invention. For example, U.S. patent publication 200710285049A1 teaches a portable jump starter providing connections or outlets on the unit that may be utilized to power consumer devices, which are separate and not structurally combinable with the jump starter.

### SUMMARY OF INVENTION

A portable jump starter for vehicles is adapted to also power an appliance module specially configured for the jump starter. The jump starter includes a hand-held case containing a battery and components to provide a direct current power supply to start a vehicle. It includes a receiving station within the case that also includes an electrical outlet connected to the battery.

The jump starter includes a module that is a self-contained appliance powered by electricity from the battery and is adapted to be inserted into the receiving station. The module includes a mating electrical receptacle that mates with the electrical outlet in the receiving station.

Preferably, the receiving station has at least three walls with splines on the bottom wall, and optionally on two side walls. The splines are adapted to mate with channels on the module which then prevent lateral movement of the module once engaged in the receiving station.

Optional retaining blocks, immediately adjacent the receiving station, are adapted to prevent vertical movement of the module out of the receiving station. Preferably, the electrical receptacle in the module is recessed within a wall of the module so that it mates with the electrical outlet and remains flush with the wall of the module.

The module may include: a 12-volt power inverter to convert direct current from the battery to alternating current used for many appliances, which may be common 120-volt in the U.S. or may be other voltages for application in other countries.

A variety of appliance modules are anticipated for uses in situations commonly requiring portable power sources. Specific examples may include a portable digital media player and a hard drive with speakers adapted to enable the jump starter to provide a portable sound system; a 12-volt air compressor; an emergency weather radio; an emergency light; a 12-volt direct current fan; a portable television; a direct current charger adapted to charge a device; and an outlet for 120 volt alternating current.

Optional adaptors may connect the modules to another power source. The adaptors enable connection to an external 12-volt battery; a direct current voltage regulator; an alternating current transformer; and a vehicle cigarette lighter.

### Technical Problem

Portable jump starters often have limited uses other than jump starting a vehicle. While electrical outlets on the jump starter are sometimes available to power other devices, jump starters do not include modular appliances that would add versatility to suit individual needs.

### Solution to Problem

The solution is a portable jump starter with a receiving station for an integrated yet removable appliance module that would yield multiple useful applications for the jump starter to suit individual needs.

### Advantageous Effects of Invention

A variety of such appliance modules that are removable would make the jump starter more versatile. Additionally, providing adaptors to permit the modules to function without the jump-starter provides more choices for the consumer and addresses problem that may arise in the event that the jump starter's battery runs out of power. An example is using a connection to a vehicle's cigarette lighter to alternatively power the module.

### BRIEF DESCRIPTION OF DRAWINGS

The drawings illustrate preferred embodiments of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is an exploded rear perspective of a jump starter.

FIG. 2 is a front perspective of a case shown in FIG. 1.

FIG. 3 is front perspective view of the jump starter shown in FIG. 1.

FIG. 4 is a front perspective of the case shown in FIG. 1.

FIG. 5 is a rear perspective of a jump starter with a flush mounted electrical outlet.

FIG. 6 illustrates various adaptors usable with a module.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

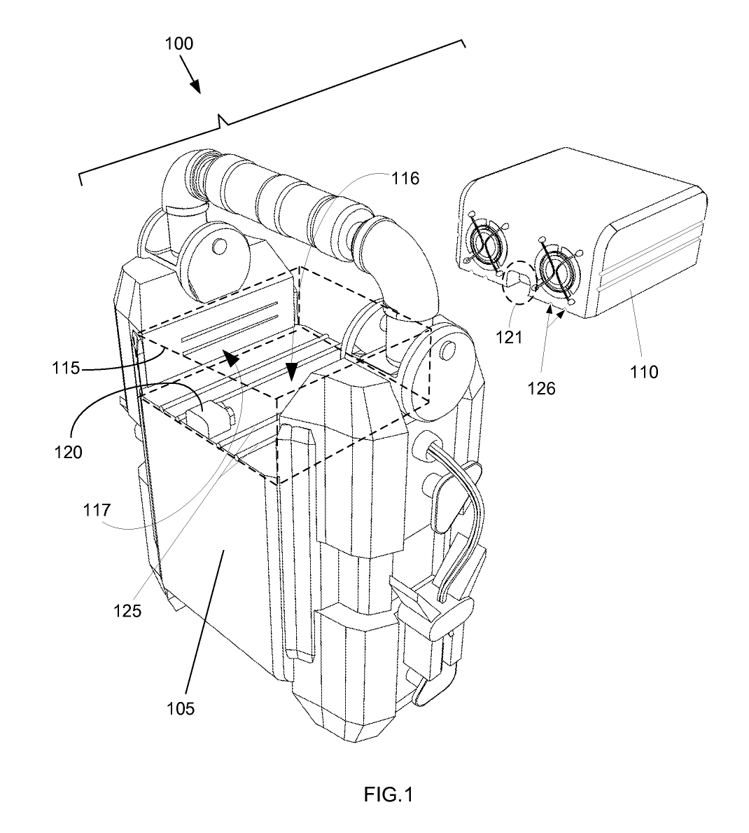

FIG. 1 shows an exploded rear perspective of a jump starter (100). The components of the jump starter (100) include: a case (105); a receiving station (115), which approximately includes the volume and components within the dashed enclosure in FIG. 1; and a module (110). In FIG. 1, the module (110) is shown removed from the receiving station (115).

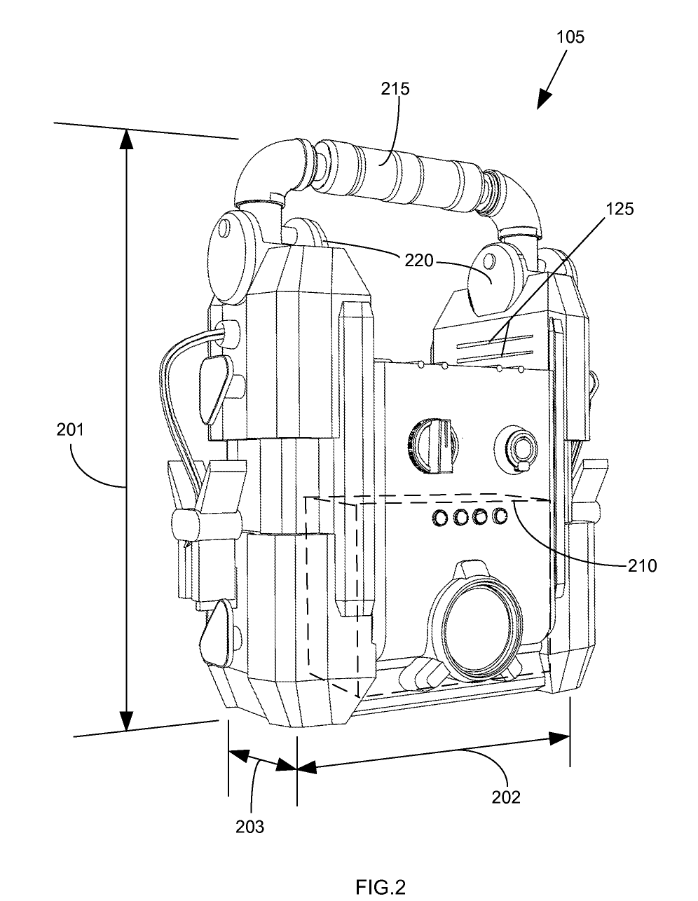

FIG. 2 shows a front perspective of the case (105) comprising a height (201); a width (202); and a depth (203). The case (105) is adapted to be hand-held and to contain a battery (210), shown within the dashed enclosure, and components to provide a direct current power supply to start a vehicle. The battery and components, such as alligator-type clamps, voltage selectors, current selectors, all are well known in the field. A preferred handle (215) is cylindrical and conveniently contoured so that the case is easily hand-held. The handle (215) may rotate to enable further compaction of the case (105) volume or to facilitate engagement and locking in the module (110) to the case (105).

The receiving station (115) is configured within the height (201); the width (202); and the depth (203) of the case (105), which is to say that the case (105) fully contains the module (110) once the module (110) is inserted into the case (105). The receiving station (115) is preferably located at the top of the case (105) so that the heavy battery (210) adds vertical stability to the jump starter (100), especially with the module (110) removed. The receiving station (115) may be located at other locations in the case. The receiving station (115) comprises an electrical outlet (120) connected to provide electricity from the battery (210).

The electrical outlet (120) is preferable at the rear of the case, as shown in FIG. 1. This location is preferable because once the electrical outlet (120) is engaged with an electrical receptacle (121) in the module (110), it provides added structural stability to the seating of the module (110) within the receiving station (115). The electrical receptacle (121) is and shown within the dashed oval in FIG. 1 and would include the typical male or female electrical connections necessary to mate with the electrical outlet (120) in the receiving station (115). The electrical outlet (120) is preferably configured to mate with the electrical receptacle (121) and remain flush with the wall of the module (110), as shown in FIG. 5.

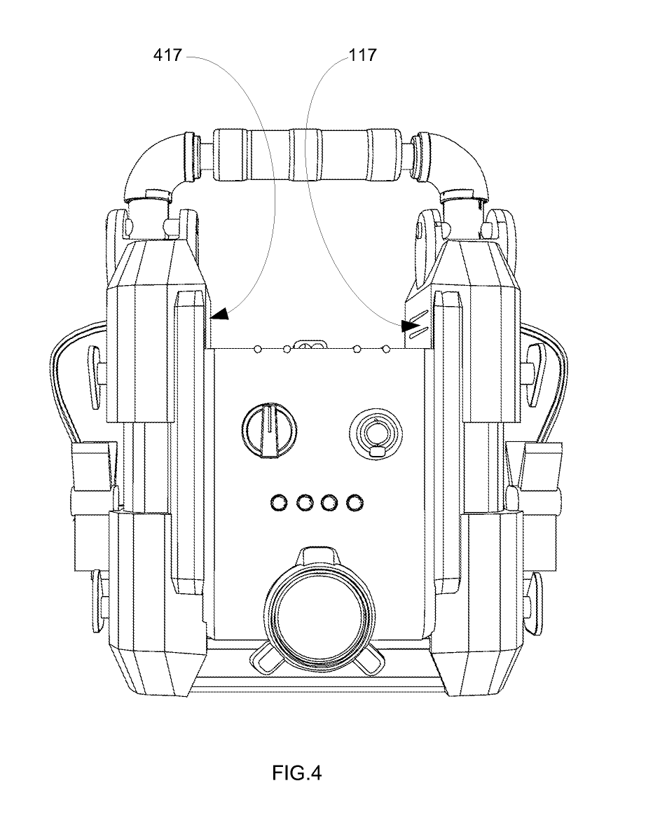

The receiving station (115) is preferably configured to define a bottom wall (116) and two side walls: a right-side wall (117); and, a left-side wall (417) shown in FIG. 4. The receiving station (115) preferably further comprises splines (125) on the bottom wall (116), the splines (125) adapted to mate with channels (126) on the module (110). Each of the splines (125) is essentially a key that is fixed to, or is an integral part of a wall of the receiving station (115) and each of the splines (125) fits into a channel (126) or keyway in the module (110).

The receiving station (115) may further include splines (125) on the two side walls: the right-side wall (117); and, the left-side wall (417), shown in FIG. 2.

The case (105) may include retaining blocks (220) immediately adjacent the receiving station (115), which are adapted to prevent vertical movement of the module (110) out of the receiving station. The retaining blocks (220) may be located at the top as shown in FIG. 2, on the bottom when the receiving station is on the bottom of the case (105), or elsewhere in order to prevent up or down movement of the module (110) within the case (105).

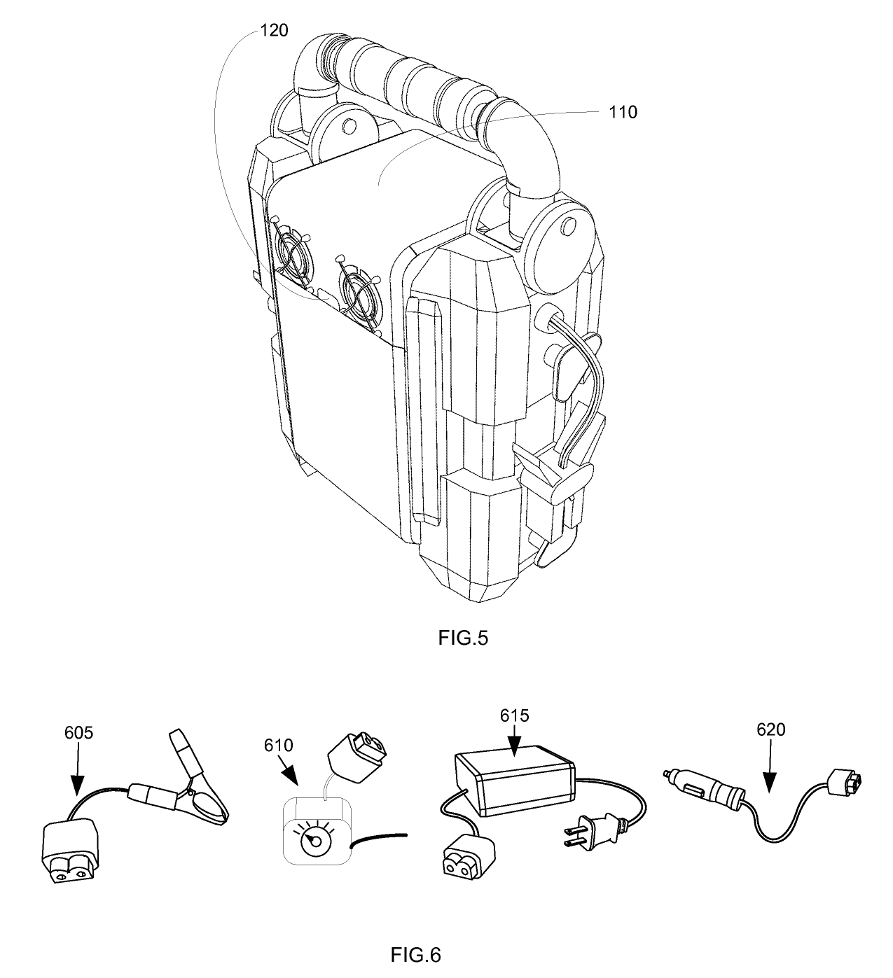

The module (110) is a self-contained appliance powered by electricity preferably from the battery (210) but may also be powered by any external DC power source. The module (110) is configured or adapted to be inserted into the receiving station (115). The module (110) includes the electrical receptacle (121) adapted to mate with the electrical outlet (120). Each module (110) has the same structural configuration. The electrical receptacle (121) in the module is preferably recessed within a wall of the module and preferably the rear wall as shown in FIG. 1. The electrical receptacle (121) is preferably accessible for powering the module (110) by other power sources, such as an external 12-volt battery; a direct current voltage regulator; an alternating current transformer; and a vehicle cigarette lighter port. For these other powering mechanisms, an adaptor may be provided to connect to each alternate power source as shown in FIG. 6. For example an adaptor for: an external 12-volt battery (605); a direct current voltage regulator (610); an alternating current transformer (615); and, a vehicle cigarette lighter (620).

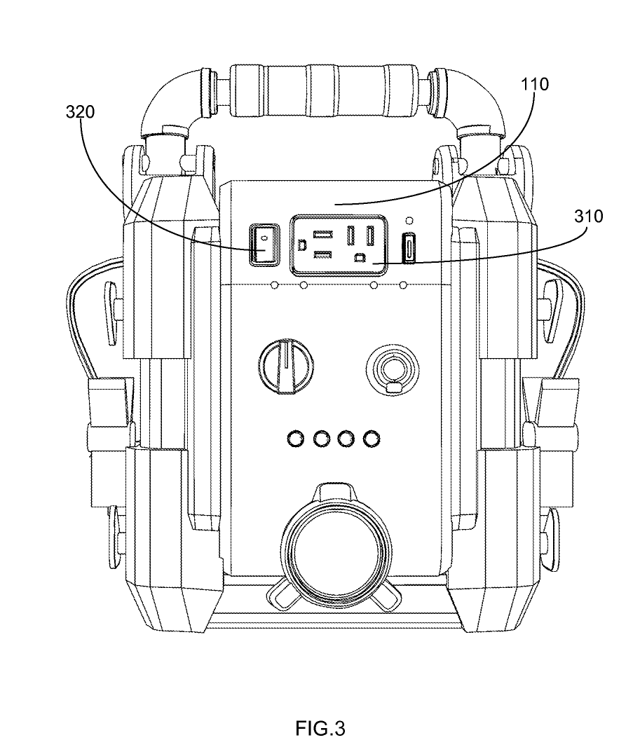

The module (110) may include a 12-volt power inverter, which converts direct current power to approximately alternating current, preferably 120-volt alternating current for United States applications and other voltages for application outside the United States. As shown in FIG. 3, this module would comprise a standard three-prong outlet (310) so that AC devices common in the United States. This may be combined a transformer to enable other direct current voltages, such as a 9-volt outlet (320).

Each module (110) is an appliance. Common appliances may include: a portable digital media player and a hard drive with speakers adapted to enable the jump starter (100) to provide a portable sound system; a 12-volt air compressor; an emergency weather radio; an emergency light; 12-volt direct current fan; a portable television; a direct current charger adapted to charge a device; and an outlet for 120-volt alternating current. These are common and well known appliances. The distinctiveness is that they are constructed in the shape of a module (110), as described above, to fit into the case.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the recreation and vehicle repair industries.

What is claimed is:

1. A portable jump starter comprising:
a case comprising a height; a width; and a depth, the case adapted to be hand-held and to contain a battery and components to provide a direct current power supply to start a vehicle;
a receiving station configured within the height, width and depth of the case, the receiving station comprising an electrical outlet connected to the battery; and,
a module comprising a self-contained appliance powered by electricity from the battery and adapted to be inserted into the receiving station, the module comprising an electrical receptacle adapted to mate with the electrical outlet.

2. The portable jump starter of claim 1, wherein the receiving station is configured to define a bottom wall and two side walls; and the receiving station further comprises:
splines on the bottom wall, the splines adapted to mate with channels on the module; and,
retaining blocks immediately adjacent the receiving station and adapted to prevent vertical movement of the module out of the receiving station.

3. The portable jump starter of claim 2:
wherein the receiving station further comprises splines on the two side walls;
wherein the electrical receptacle in the module is recessed within a wall of the module; and,
wherein the electrical outlet is configured to mate with the electrical receptacle and remain flush with the wall.

4. The portable jump starter of claim 1, wherein the module further comprises a 12-volt power inverter, which converts direct current power to alternating current.

5. The portable jump starter of claim 1, wherein the appliance comprises a portable digital media player and a hard drive with speakers adapted to enable the jump starter to provide a portable sound system.

6. The portable jump starter of claim 1, wherein the appliance comprises a 12-volt air compressor.

7. The portable jump starter of claim 1, wherein the appliance comprises an emergency weather radio.

8. The portable jump starter of claim 1, wherein the appliance comprises an emergency light.

9. The portable jump starter of claim 1, wherein the appliance comprises a 12-volt direct current fan.

10. The portable jump starter of claim 1, wherein the appliance comprises a portable television.

11. The portable jump starter of claim 1, wherein the appliance comprises a direct current charger adapted to charge a device.

12. The portable jump starter of claim 1, wherein the appliance comprises an outlet for 120 volt alternating current.

13. The portable jump starter of claim 1, wherein the module further comprises an adaptor to connect to a power source selected from the group consisting of: an external 12-volt battery; a direct current voltage regulator; an alternating current transformer; and, a vehicle cigarette lighter.
